(19) United States
(12) Patent Application Publication
(10) Pub. No.: US 2022/0279340 A1
(43) Pub. Date: Sep. 1, 2022

(54) CONFIGURATION PROVIDING DEVICE, COMMUNICATION SYSTEM, CONFIGURATION PROVIDING METHOD AND NON-TRANSITORY COMPUTER READABLE MEDIUM STORING PROGRAM

(71) Applicant: NEC Corporation, Minato-ku, Tokyo (JP)

(72) Inventors: Hidehisa TOYAMA, Tokyo (JP); Manabu Koga, Tokyo (JP)

(73) Assignee: NEC Corporation, Minato-ku, Tokyo (JP)

(21) Appl. No.: 17/762,855

(22) PCT Filed: Sep. 30, 2019
(86) PCT No.: PCT/JP2019/038510

§ 371 Date: Mar. 23, 2022

(51) Int. Cl. H04W 8/18; H04W 8/24

(52) U.S. Cl. CPC H04W 8/183; H04W 8/24

(57) ABSTRACT

A configuration work performed when a communication device is replaced is simplified. A configuration providing device includes a storage control unit for controlling first device identification information for identifying a first communication device, configuration information of the first communication device, and first user identification information for identifying a user of the first communication device to be stored in association with each other, a reception unit for receiving second device identification information for identifying a second communication device and second user identification information for identifying a user of the second communication device, and a configuration information transmission unit for transmitting the configuration information stored in association with the first user identification information corresponding to the second user identification information as configuration information for the second communication device.

### TECHNICAL FIELD

The present disclosure relates to a configuration providing device, a communication system, a configuration providing method, and a non-transitory computer readable medium storing a program.

### BACKGROUND ART

Commonly, a unique configuration is set in a communication device and the communication device is operated according to a usage environment or the like. In connection with this, for example, Patent Literature 1 discloses a database for storing parameters of equipment in association with identification information of the equipment.

### CITATION LIST

### Patent Literature

Patent Literature 1: Japanese Unexamined Patent Application Publication No. 2006-185291

### SUMMARY OF INVENTION

### Technical Problem

When a communication device needs to be replaced due to a failure or the like, it is necessary to configure a new communication device in order to use the newly installed communication device. That is, when a replacement occurs, a user of the communication device must perform a configuration work, and consequently it takes time and effort to start using the new communication device.

In the technique disclosed in Patent Literature 1, a diagnosis of equipment is performed only by using parameters associated with the identification information of the equipment, and thus the configuration work performed when the equipment is replaced is not simplified.

An object of the present disclosure is to provide a configuration providing device, a communication system, a configuration providing method, and a program which can simplify a configuration work performed when a communication device is replaced.

### Solution to Problem

In a first example aspect of the present disclosure, a configuration providing device includes:

storage control means for controlling first device identification information for identifying a first communication device, configuration information of the first communication device, and first user identification information for identifying a user of the first communication device to be stored in association with each other;

reception means for receiving second device identification information for identifying a second communication device and second user identification information for identifying a user of the second communication device; and

configuration information transmission means for transmitting the configuration information stored in association with the first user identification information corresponding to the second user identification information as configuration information for the second communication device.

In a second example aspect of the present disclosure, a communication system includes:

a second communication device in place of a first communication device; and

a configuration providing device.
The configuration providing device includes:
   storage control means for controlling first device identification information for identifying the first communication device, configuration information of the first communication device, and first user identification information for identifying a user of the first communication device to be stored in association with each other;
   reception means for receiving second device identification information for identifying the second communication device and second user identification information for identifying a user of the second communication device; and
   configuration information transmission means for transmitting the configuration information stored in association with the first user identification information corresponding to the second user identification information as configuration information for the second communication device, and
the second communication device comprises:
   processing means for performing predetermined processing based on the configuration information transmitted from the configuration providing device.

In a third example aspect of the present disclosure, a configuration providing method includes:

storing first device identification information for identifying a first communication device, configuration information of the first communication device, and first user identification information for identifying a user of the first communication device in association with each other;

receiving second device identification information for identifying a second communication device and second user identification information for identifying a user of the second communication device; and

transmitting the configuration information stored in association with the first user identification information corresponding to the second user identification information as configuration information for the second communication device.

A fourth example aspect of the present disclosure is a non-transitory computer readable medium storing a program for causing a computer to execute:

a storage control step of controlling first device identification information for identifying a first communication device, configuration information of the first communication device, and first user identification information for identifying a user of the first communication device to be stored in association with each other;

a reception step of receiving second device identification information for identifying a second communication device and second user identification information for identifying a user of the second communication device; and

a configuration information transmission step of transmitting the configuration information stored in association with the first user identification information corresponding to the second user identification information as configuration information for the second communication device.

### ADVANTAGEOUS EFFECTS OF INVENTION

According to the present disclosure, it is possible to provide a configuration providing device, a communication system, a configuration providing method, and a program which can simplify a configuration work performed when a communication device is replaced.

### BRIEF DESCRIPTION OF DRAWINGS

FIG. 1 is a block diagram showing an example of a configuration of a configuration providing device according to an outline of an example embodiment;

FIG. 2 is a schematic diagram showing an example of a configuration of a communication system according to the example embodiment;

FIG. 3 is a block diagram showing an example of a functional configuration of a configuration providing device according to the example embodiment;

FIG. 4 is a block diagram showing an example of a functional configuration of the communication device according to the example embodiment;

FIG. 5 is a block diagram showing an example of a functional configuration of a terminal device according to the example embodiment;

FIG. 6 is a schematic diagram showing an example of a hardware configuration of the configuration providing device according to the example embodiment;

FIG. 7 is a schematic diagram showing an example of a hardware configuration of the terminal device according to the example embodiment;

FIG. 8 is a sequence chart showing a flow of processing when the communication device is provided from a device administrator to a user; and

FIG. 9 is a sequence chart showing a flow of processing when the communication device is replaced.

### DESCRIPTION OF EMBODIMENT

In order to clarify the explanation, the following description and drawings are omitted and simplified as appropriate. In each of the drawings, the same elements are given the same reference signs, and repeated explanations are omitted as necessary.

### Outline of Example Embodiment

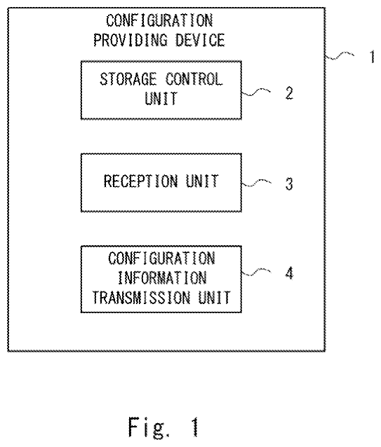

Before describing the details of the example embodiment, the outline of the example embodiment will be described. FIG. 1 is a block diagram showing an example of a configuration of a configuration providing device 1 according to the outline of the example embodiment. The configuration providing device 1 provides configuration information to the communication device. In particular, the configuration providing device 1 provides the configuration information of a first communication device to a second communication device. As shown in FIG. 1, the configuration providing device 1 includes a storage control unit 2, a reception unit 3, and a configuration information transmission unit 4.

The storage control unit 2 performs control to store first device identification information for identifying a first communication device, configuration information of the first communication device, and first user identification information for identifying a user of the first communication device in association with each other. The storage control unit 2 stores the information in a storage device (not shown). Note that the storage device may be provided in the configuration providing device 1 or may be provided as a separate device.

The reception unit 3 receives second device identification information for identifying the second communication device and second user identification information for identifying a user of the second communication device. Specifically, the second communication device is, for example, a communication device newly used in place of the first communication device. The second device identification information and the second user identification information are transmitted from, for example, a terminal device used by the user.

The configuration information transmission unit 4 transmits configuration information (i.e., configuration information of the first communication device) stored in association with the first user identification information corresponding to the second user identification information to the second communication device as configuration information for the second communication device. Here, when the identification information corresponds to some information, it can also be said that the identification information matches the information. For example, when the first user identification information is “user 01” and the second user identification information is also “user 01”, the configuration information transmission unit 4 transmits the configuration information of the first communication device stored in association with “user 01” to the second communication device. However, when two pieces of identification information are linked as identification information indicating the same user, it can be said that the two pieces of identification information correspond to each other even if the two pieces of identification information do not match. For example, when the first user identification information “user 01” and the second user identification information “user A” are previously linked as identification information indicating the same user, the configuration information transmission unit 4 transmits the configuration information of the first communication device stored in association with “user 01” to the second communication device.

Thus, the configuration providing device 1 transmits the configuration information of the first communication device to the second communication device based on the device identification information and the user identification information. Therefore, in the second communication device, since the configuration information of the first communication device can be used, a configuration work of the second communication device can be simplified.

### Details of Example Embodiment

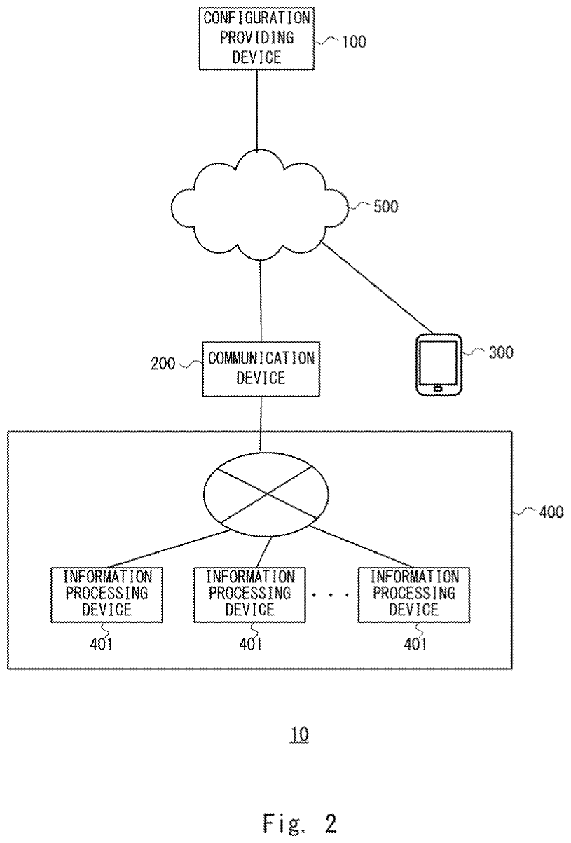

Next, details of the example embodiment will be described. FIG. 2 is a schematic diagram showing an example of a configuration of a communication system 10 according to the example embodiment. In FIG. 2, a terminal device 300 is shown in addition to the communication system 10.

The communication system 10 includes a configuration providing device 100, a communication device 200, and an intra-organization network 400. The configuration providing device 100 and the communication device 200 are communicably connected to each other via a communication network 500 such as the Internet. The terminal device 300 is also communicably connected to the configuration providing device 100 via the communication network 500.

The communication device 200 is installed between the communication network 500 and the intra-organization network 400, and relays communication between the intra-organization network 400 and the communication network 500. The communication device 200 is, for example, a device (such as a UTM (Unified

Threat Management) device) having a function as an IDS (Intrusion Detection System) or IPS (Intrusion Prevention System), but may be another communication equipment such as a firewall or router.

As shown in FIG. 2, for example, the intra-organization network 400 includes a plurality of information processing devices 401 such as a personal computer and a server, and is a network belonging to an organization (hereinafter referred to as a user) such as a company.

The configuration providing device 100 manages the user and the communication device 200, and is, for example, a server device. Details of the function and configuration of the configuration providing device 100 will be described later.

The terminal device 300 is a terminal used by the user for communication with the configuration providing device 100, and is, for example, a terminal such as a smartphone or a tablet. In this example embodiment, as will be described later, the terminal device 300 reads a two-dimensional code such as a QR code (registered trademark).

In this example embodiment, the configuration providing device 100 is, for example, a device owned by a device administrator. Here, the device administrator means an organization that provides the communication device 200 to the user (i.e., an organization including the intra-organization network 400) and manages the communication device 200. When the communication device 200 is sent to the user, the device administrator also sends, to the user, a two-dimensional code including device identification information (device ID) of the communication device 200, which is to be sent. For example, the device administrator sends the two-dimensional code together with the communication device 200 by attaching the two-dimensional code to a casing or a packaging member of the communication device 200, or by packing the two-dimensional code together with the communication device 200. More specifically, the two-dimensional code also includes access information (e.g., the URL (Uniform Resource Locator) of a web portal provided by the configuration providing device 100) for accessing the configuration providing device 100.

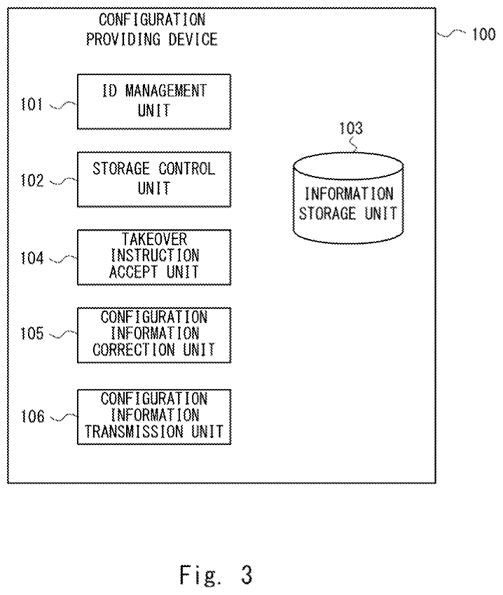

FIG. 3 is a block diagram showing an example of the functional configuration of the configuration providing device 100. As shown in FIG. 3, the configuration providing device 100 includes an ID management unit 101, a storage control unit 102, an information storage unit 103, a takeover instruction accept unit 104, a configuration information correction unit 105, and a configuration information transmission unit 106.

The ID management unit 101 performs processing for managing device IDs, user IDs, and user passwords. The device ID is an ID for identifying the communication device 200, and corresponds to the device identification information described above. The user ID is an ID for identifying the user and corresponds to the user identification information described above. The user password is information used for authenticating the user identified by the user ID. For the authentication, information other than a password may be used.

The ID management unit 101 receives the device ID, the user ID and, the user password from the user provided with the communication device 200. Specifically, the ID management unit 101 receives the information transmitted from the terminal device 300 used by the user through the web portal provided by the configuration providing device 100. The ID management unit 101 corresponds to the reception unit 3 shown in FIG. 1.

The storage control unit 102 controls storage processing. Specifically, the storage control unit 102 controls the information storage unit 103 to store the user ID and the user password in association with each other. The storage control unit 102 also controls the information storage unit 103 to store the user ID and the device ID in association with each other. The storage control unit 102 controls the information storage unit 103 to store the configuration information of the communication device 200 in association with the device ID and the user ID. The storage control unit 102 controls the information storage unit 103 to store a list of failed communication devices 200 (hereinafter referred to as a failed device list) for each user. The information stored in the storage control unit 102 is not limited to this. For example, the storage control unit 102 may control the information storage unit 103 to store communication history information received from the communication device 200 in association with the device ID of the communication device 200. The storage control unit 102 corresponds to the storage control unit 2 shown in FIG. 1.

The information storage unit 103 stores various data necessary for processing of the configuration providing device 100 such as the device ID, the user ID, the user password, the configuration information, the failure device list, and the like.

The takeover instruction accept unit 104 accepts an instruction from the user about taking-over of the configuration information. In this example embodiment, the takeover instruction accept unit 104 accepts an instruction transmitted from the terminal device 300. The takeover instruction accept unit 104 accepts an instruction as to whether or not to take over the configuration information. When there are a plurality of communication devices 200 as devices from which the configuration information is to be taken over (hereinafter referred to as a takeover source), the takeover instruction accept unit 104 accepts an instruction to select one of the communication devices 200.

When the specification of the communication device 200 which is a device to take over the configuration information (hereinafter referred to as a takeover destination) is different from the specification of the communication device 200 of a takeover source, the configuration information correction unit 105 corrects the configuration information stored in association with the device ID of the communication device 200 of the takeover source in accordance with the difference between the specifications. For example, when the specification of the communication device has been changed due to, for example, a version upgrade, the configuration information may not be used as it is. For this reason, the configuration information correction unit 105 corrects the configuration information of the communication device 200 of the takeover source according to the difference between the specifications, thereby changing the configuration information for the communication device 200 of the takeover source to the configuration information for the communication device 200 of the takeover destination. The configuration information correction unit 105 changes the configuration information by using, for example, a conversion rule predetermined for each difference of specifications.

The configuration information transmission unit 106 transmits the configuration information of the communication device 200 of a takeover source to the communication device 200 of a takeover destination as the configuration information for the communication device. When the specification of the communication device of the takeover destination is different from the specification of the communication device of the takeover source, the configuration information transmission unit 106 transmits the changed configuration information corresponding to the difference between the specifications to the communication device 200 of the takeover destination. That is, in this case, the configuration information transmission unit 106 transmits the configuration information corrected by the configuration information correction unit 105. The configuration information transmission unit 106 corresponds to the configuration information transmission unit 4 shown in FIG. 1.

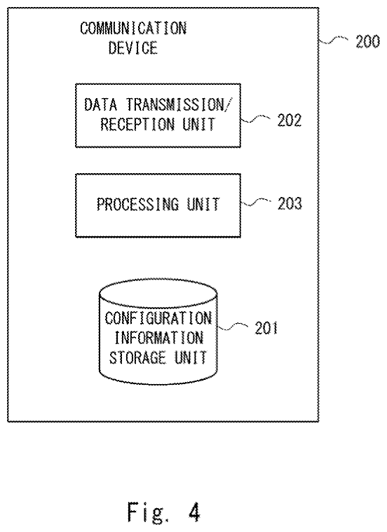

FIG. 4 is a block diagram showing an example of a functional configuration of the communication device 200. As shown in FIG. 4, the communication device 200 includes a configuration information storage unit 201, a data transmission/reception unit 202, and a processing unit 203.

The configuration information storage unit 201 stores the configuration information of the communication device 200.

The data transmission/reception unit 202 performs data transmission/reception processing with other devices. For example, the data transmission/reception unit 202 performs processing for transmitting the configuration information currently set in the communication device 200 to the configuration providing device 100 and processing for receiving new configuration information from the configuration providing device 100.

The processing unit 203 performs predetermined processing based on the configuration information set in the communication device 200. When new configuration information is transmitted from the configuration providing device 100, the processing unit 203 performs predetermined processing based on the new configuration information. For example, the processing unit 203 monitors the communication and performs processing for transmitting the communication history information of the communication device 200 to the configuration providing device 100. Note that the communication history information transmitted to the configuration providing device 100 may be used, for example, for an insurance coverage trigger requirement of cyber insurance covering the intra-organization network 400.

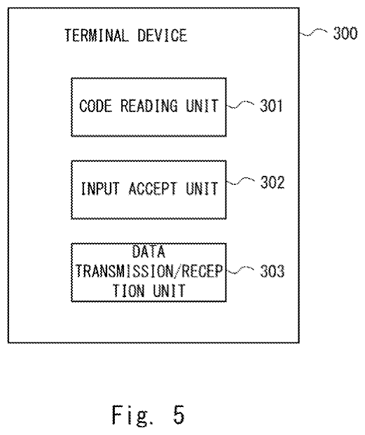

FIG. 5 is a block diagram showing an example of the functional configuration of the terminal device 300. As shown in FIG. 5, the terminal device 300 includes a code reading unit 301, an input accept unit 302, and a data transmission/reception unit 303.

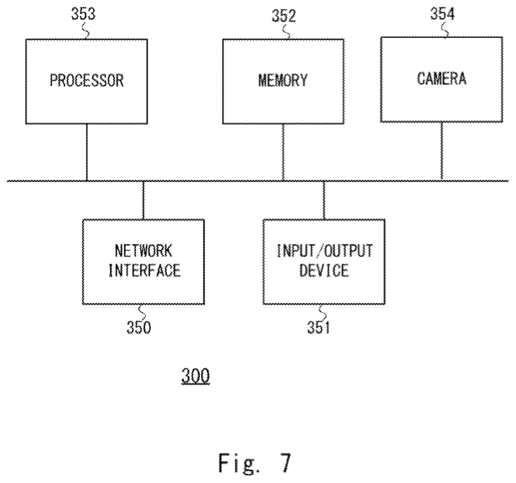

The code reading unit 301 reads information included in the two-dimensional code. Specifically, the code reading unit 301 performs image processing on image data captured by a camera 354 (see FIG. 7) included in the terminal device 300, and reads out the information. As described above, in this example embodiment, since the two-dimensional code includes the device ID and the access information (URL), the code reading unit 301 reads the device ID and the access information.

The input accept unit 302 accepts an input from the user. Specifically, the input accept unit 302 accepts input information input via an input/output device 351 (see FIG. 7) included in the terminal device 300.

The data transmission/reception unit 303 performs data transmission/reception processing with other devices. For example, the data transmission/reception unit 303 identifies an access destination based on the access information read by the code reading unit 301 and transmits/receives data. In this example embodiment, the data transmission/reception unit 303 accesses the web portal indicated by the URL read by the code reading unit 301. The data transmission/reception unit 303 transmits the device ID read by the code reading unit 301, and the user ID and the user password accepted by the input accept unit 302 to the configuration providing device 100. Although authentication is required in this example embodiment, authentication may not be required. In this case, the transmission of authentication information, that is, the transmission of the user password, is unnecessary. In this way, the data transmission/reception unit 202 associates the device ID read from the two-dimensional code with the input user ID and transmits them to the configuration providing device 100. Further, the data transmission/reception unit 202 transmits a response according to the input received by the input accept unit 302 to the configuration providing device 100 in response to an inquiry from the takeover instruction accept unit 104 of the configuration providing device 100. Note that the data transmission/reception unit 202 may transmit or receive various information to or from the configuration providing device 100.

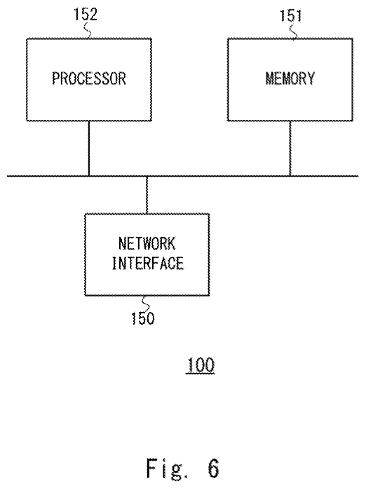

FIG. 6 is a schematic diagram showing an example of a hardware configuration of the configuration providing device 100. As shown in FIG. 6, the configuration providing device 100 includes a network interface 150, a memory 151, and a processor 152.

The network interface 150 is used to communicate with any other device, such as the communication device 200 and the terminal device 300. The network interface 150 may include, for example, a network interface card (NIC).

The memory 151 is composed of, for example, a combination of a volatile memory and a non-volatile memory. The memory 151 is used to store software (computer programs) including one or more instructions to be executed by the processor 152, data used for various processing of the configuration providing device 100, and the like. The information storage unit 103 shown in FIG. 3 is implemented, for example, by the memory 151, but may be implemented by another storage device.

The processor 152 reads and executes the software (computer programs) from the memory 151 to perform processing of each of the components shown in FIG. 3. Specifically, the processor 152 performs processing of the ID management unit 101, the storage control unit 102, the takeover instruction accept unit 104, the configuration information correction unit 105, and the configuration information transmission unit 106.

The processor 152 may be, for example, a microprocessor, an MPU (Micro Processor Unit), or a CPU (Central Processing Unit). The processor 152 may include a plurality of processors.

In this way, the configuration providing device 100 has a function as a computer.

The communication device 200 also has a hardware configuration as shown in FIG. 6. That is, the processing of the communication device 200 is implemented by, for example, execution of a program by a processor. More specifically, the processor of the communication device 200 performs processing of the data transmission/reception unit 202 and the processing unit 203. The configuration information storage unit 201 of the communication device 200 is implemented by, for example, a memory provided in the communication device 200. In this way, the communication device 200 has a function as a computer.

FIG. 7 is a schematic diagram showing an example of a hardware configuration of the terminal device 300. As shown in FIG. 7, the terminal device 300 includes a network interface 350, an input/output device 351, a memory 352, a processor 353, and the camera 354.

The network interface 350 is used to communicate with any other device, such as the configuration providing device 100. The network interface 350 may include, for example, a network interface card (NIC).

The input/output device 351 is, for example, a touch panel, and is composed of an input device for receiving an input from the user and a display device for performing display and output.

The memory 352 is composed of, for example, a combination of a volatile memory and a non-volatile memory. The memory 352 is used to store software (computer programs) including one or more instructions to be executed by the processor 353, data used for various processing of the terminal device 300, and the like.

The processor 353 reads and executes the software (computer programs) from the memory 352 to perform processing of each of the components shown in FIG. 5. Specifically, the processor 353 performs processing of the code reading unit 301, the input accept unit 302, and the data transmission/reception unit 303.

The processor 353 may be, for example, a microprocessor, MPU, or CPU. The processor 353 may include a plurality of processors.

In this way, the terminal device 300 has a function as a computer.

The above program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

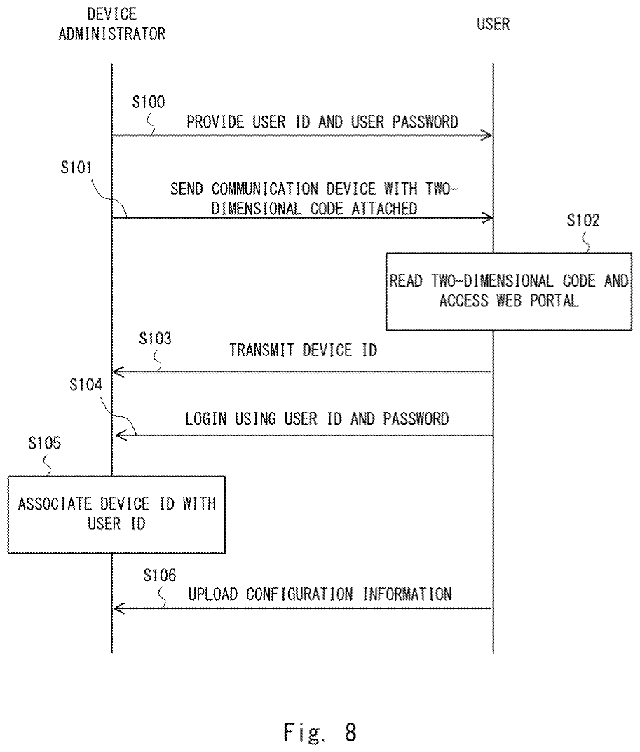

Next, a flow of processing will be described based on a sequence chart. FIG. 8 is a sequence chart showing a flow of processing when the communication device 200 (the communication device 200 of the takeover source) is provided from the device administrator to the user. Hereinafter, descriptions will be given with reference to FIG. 8.

In Step S100, the device administrator provides the user with a user ID and a user password. Note that the device administrator may, for example, transmit the user ID and the user password in writing, an e-mail or the like. For example, the ID management unit 101 may transmit an e-mail including the user ID and the user password to the user's e-mail address.

Next, in Step S101, the device administrator sends the communication device 200 to the user. At this time, the device administrator sends the communication device 200 together with the two-dimensional code. As described above, the two-dimensional code includes the device ID of the communication device 200 and the access information for accessing the configuration providing device 100. The device administrator may send the communication device 200 to which the configuration information customized for the user of the destination is applied. In this case, this configuration information is stored in the information storage unit 103 together with the device ID of the communication device 200.

Next, in Step S102, the user uses the terminal device 300 to read the two-dimensional code received in Step S101 and accesses the web portal provided by the configuration providing device 100. In Step S102, the code reading unit 301 of the terminal device 300 acquires the device ID and the URL of the web portal included in the two-dimensional code, and the data transmission/reception unit 303 of the terminal device 300 accesses the web portal based on the acquired URL. In this manner, in this example embodiment, the two-dimensional code includes the access information for accessing the configuration providing device 100, so that the configuration providing device 100 can be easily accessed.

In Step S103, the data transmission/reception unit 303 of the terminal device 300 transmits the device ID read from the two-dimensional code to the configuration providing device 100.

In Step S104, the input accept unit 302 of the terminal device 300 accepts an input of the user ID and the user password from the user. The user inputs the user ID and the user password received in Step S 100. The data transmission/reception unit 303 of the terminal device 300 transmits the input user ID and user password to the configuration providing device 100. In this manner, the user can login to the web portal. The authentication processing for the login is performed, for example, by the ID management unit 101 of the configuration providing device 100.

When the login is successful, in Step S105, the storage control unit 102 of the configuration providing device 100 associates the device ID with the user ID transmitted from the terminal device 300 in Steps S103 and S104 and stores them in the information storage unit 103. That is, the storage control unit 102 stores the user ID received together with the device ID in the information storage unit 103 in association with the device ID. Thus, the identification information of the communication device 200 used by the user is associated with the identification information of the user. Therefore, according to this example embodiment, the identification information of the communication device 200 can be appropriately associated with the identification information of the user who actually uses the communication device 200. An additional explanation is provided here. For example, it is assumed that the device administrator associates the identification information of the communication device 200 with the identification information of a user of a shipping destination before sending the communication device 200. In this case, when the communication device 200 is delivered to a different user due to a misdelivery or the like, the actual user does not match the user managed by the configuration providing device 100. In this case, for example, there is a problem that the user who should have received the communication device 200 uses his/her own user ID to browse the communication history information in the environment of the user who erroneously received the communication device 200. For this reason, no misdelivery should be allowed. On the other hand, according to this example embodiment, since the identification information of the user who actually received the communication device 200 and the identification information of the communication device 200 are associated with each other as described above, the above-mentioned problem can be solved.

After Step S105, in Step S106, the latest configuration information applied to the communication device 200 is transmitted (uploaded) from the communication device 200 to the configuration providing device 100. The communication device 200 transmits the latest configuration information applied to this communication device to the configuration providing device 100 together with the device ID of this communication device. Note that the processing in Step S106 may be performed periodically, or may be performed every time the configuration is changed in the communication device 200. The storage control unit 102 stores the latest configuration information applied to the communication device 200 in the information storage unit 103 in association with the device ID.

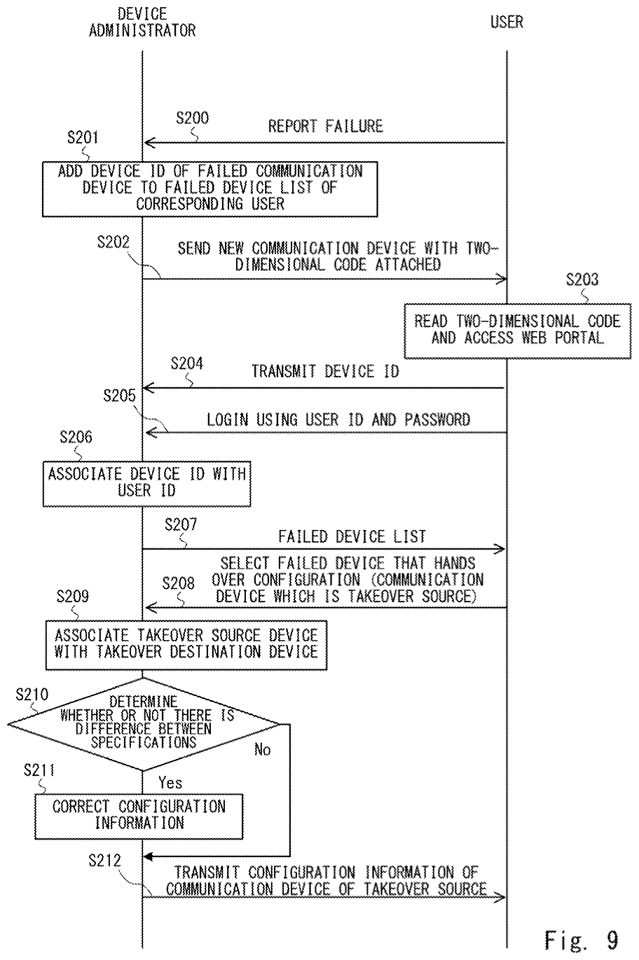

FIG. 9 is a sequence chart showing a flow of processing when the communication device 200 is replaced. Hereinafter, descriptions will be given with reference to FIG. 9. In the example shown in FIG. 9, a replacement occurs due to a failure, but the reason for a replacement is not limited to this.

In Step S200, the user notifies the device administrator of the failure of the communication device 200. The notification may be transmitted from the communication device 200 to the configuration providing device 100. For example, when a failure notification switch provided in the communication device 200 is operated, a notification about a failure may be transmitted from the communication device 200 to the configuration providing device 100.

In Step S201, the storage control unit 102 of the configuration providing device 100 adds the device ID of the failed communication device 200 to the failed device list of the user using the failed communication device 200 and stores the failed device list in the information storage unit 103.

Next, in Step S202, the device administrator sends a new communication device 200 to the user. At this time, the device administrator sends the new communication device 200 together with the two-dimensional code as in the above-described Step S101.

Next, in Step S203, as in Step S102, the user uses the terminal device 300 to read the two-dimensional code and access the web portal.

In Step S204, as in Step S103, the data transmission/reception unit 303 of the terminal device 300 transmits the device ID of the new communication device 200 read from the two-dimensional code to the configuration providing device 100.

In Step S205, as in Step S104, the data transmission/reception unit 303 of the terminal device 300 transmits the input user ID and user password to the configuration providing device 100. In this manner, the user can login to the web portal.

When the login is successful, in Step S206, in a manner similar to the above Step S105, the storage control unit 102 of the configuration providing device 100 associates the device ID with the user ID transmitted from the terminal device 300 in Steps S204 and S205 and stores them in the information storage unit 103.

Next, in Step S207, the takeover instruction accept unit 104 transmits the failed device list for the user logged in in Step S205 to the terminal device 300. When a plurality of communication devices 200 of the user are faulty, the failed device list includes device IDs of those communication devices 200.

Next, in Step S208, the user selects from the failed device list the failed device that hands over the configuration, that is, the communication device 200 which is the takeover source of the configuration information. Specifically, the terminal device 300 transmits a selection instruction to the configuration providing device 100. The takeover instruction accept unit 104 accepts the selection instruction. In this manner, the user designates which communication device 200 from among the failed communication devices 200 is to be replaced. By doing so, the user can cause the configuration information of the appropriate communication device 200 to be taken over to the new communication device 200.

The takeover instruction accept unit 104 may make an inquiry to the user (the terminal device 300) as to whether or not to take over the configuration information, and may receive an instruction as to whether or not to take over the configuration information from the terminal device 300. That is, the configuration information transmission unit 106 may transmit the configuration information of the communication device 200 of the takeover source to the new communication device 200 when the instruction to take over the configuration information is received. In this way, the user can also use the new communication device 200 without taking over the configuration information.

Here, the communication device 200 of the takeover source is referred to as a first communication device, the communication device 200 of the takeover destination is referred to as a second communication device, and the device IDs thereof are referred to as first device identification information and second device identification information, respectively. The user ID transmitted from the terminal device 300 to the configuration providing device 100 together with the first device identification information is referred to as first user identification information, and the user ID transmitted from the terminal device 300 to the configuration providing device 100 together with the second device identification information is referred to as second user identification information. Thus, the above-described processing of the takeover instruction accept unit 104 can also be described as follows.

The takeover instruction accept unit 104 accepts an instruction as to whether or not to take over the configuration information stored in association with the first user identification information corresponding to the second user identification information. When there are a plurality of pieces of first device identification information stored in association with the first user identification information corresponding to the second user identification information, the takeover instruction accept unit 104 accepts an instruction to select one piece of the first device identification information.

After Step S208, in Step S209, the storage control unit 102 of the configuration providing device 100 associates the device ID of the communication device 200 of the takeover source with the device ID of the communication device 200 of the takeover destination, and stores them in the information storage unit 103.

Next, in Step S210, the configuration information correction unit 105 determines whether or not the specification of the communication device 200 of the takeover destination differs from the specification of the communication device 200 of the takeover source. This can be done, for example, by comparing specification information for each type of communication device. If the specification of the communication device 200 of the takeover destination differs from the specification of the communication device 200 of the takeover source (Yes in Step S210), the processing proceeds to Step S211, whereas if the specification of the communication device 200 of the takeover destination does not differ from the specification of the communication device 200 of the takeover source (No in Step S210), the processing proceeds to Step S212.

In Step S211, the configuration information correction unit 105 corrects the configuration information of the communication device 200 of the takeover source according to the difference between the specifications.

In Step S212, the configuration information transmission unit 106 transmits the configuration information of the communication device 200 of the takeover source to the communication device 200 of the takeover destination. Specifically, the configuration information transmission unit 106 transmits the configuration information stored in association with the communication device 200 (the device ID) selected in Step S208 to the communication device 200 of the takeover destination as the configuration information for the communication device 200 of the takeover destination. However, when the configuration information is corrected in Step S211, the configuration information changed according to the difference between the specifications is transmitted as the configuration information for the communication device 200 of the takeover destination. Thus, even when the specification is changed, the appropriate configuration can be set in the new communication device 200.

When the configuration information is taken over, the communication history information of the communication device 200 of the takeover source and the newly acquired communication history information of the communication device 200 of the takeover destination may be stored in association with each other. That is, when the configuration information transmission unit 106 transmits the configuration information of the communication device 200 of the takeover source to the communication device 200 of the takeover destination, the storage control unit 102 of the configuration providing device 100 may perform control as follows. The storage control unit 102 may perform control so as to store the communication history information of the communication device 200 of the takeover source in association with the communication history information of the communication device 200 of the takeover destination. In this way, the communication history information can also be taken over.

Although the present disclosure has been described with reference to the above example embodiment, the present disclosure is not limited thereto. Various changes can be made to the configuration and details of the disclosure within the scope of the disclosure that can be understood by those skilled in the art.

The whole or part of the example embodiment disclosed above can be described as, but not limited to, the following supplementary notes.

### Supplementary Note 1

A configuration providing device comprising:

storage control means for controlling first device identification information for identifying a first communication device, configuration information of the first communication device, and first user identification information for identifying a user of the first communication device to be stored in association with each other;

reception means for receiving second device identification information for identifying a second communication device and second user identification information for identifying a user of the second communication device; and

configuration information transmission means for transmitting the configuration information stored in association with the first user identification information corresponding to the second user identification information as configuration information for the second communication device.

### Supplementary Note 2

The configuration providing device according to Supplementary note 1, further comprising:

instruction accept means for accepting an instruction as to whether or not to take over the configuration information stored in association with the first user identification information corresponding to the second user identification information, wherein

when the instruction to take over the configuration information is received, the configuration information transmission means transmits the configuration information as the configuration information for the second communication device.

### Supplementary Note 3

The configuration providing device according to Supplementary note 2, wherein

when there are a plurality of pieces of the first device identification information stored in association with the first user identification information corresponding to the second user identification information, the instruction accept means further accepts an instruction to select one piece of the first device identification information, and

the configuration information transmission means transmits the configuration information stored in association with the selected first device identification information as the configuration information for the second communication device.

### Supplementary Note 4

The configuration providing device according to any one of Supplementary notes 1 to 3, wherein

when the configuration information transmission means transmits the configuration information of the first communication device as the configuration information for the second communication device, the storage control means further controls communication history information of the first communication device and communication history information of the second communication device to be stored in association with each other.

### Supplementary Note 5

The configuration providing device according to any one of Supplementary notes 1 to 4, wherein

when a specification of the second communication device is different from a specification of the first communication device, the configuration information transmission means transmits the configuration information changed according to the difference between the specification of the second communication device and the specification of the first communication device as the configuration information for the second communication device.

### Supplementary Note 6

The configuration providing device according to any one of Supplementary notes 1 to 5, wherein

the first device identification information is read from a first two-dimensional code sent together with the first communication device and received together with the first user identification information, and

the second device identification information is read from a second two-dimensional code sent together with the second communication device and received together with the second user identification information.

### Supplementary Note 7

A communication system comprising:

a second communication device in place of a first communication device; and

a configuration providing device, wherein
the configuration providing device comprises:
   storage control means for controlling first device identification information for identifying the first communication device, configuration information of the first communication device, and first user identification information for identifying a user of the first communication device to be stored in association with each other;
   reception means for receiving second device identification information for identifying the second communication device and second user identification information for identifying a user of the second communication device; and
   configuration information transmission means for transmitting the configuration information stored in association with the first user identification information corresponding to the second user identification information as configuration information for the second communication device, and
the second communication device comprises:
   processing means for performing predetermined processing based on the configuration information transmitted from the configuration providing device.

### Supplementary Note 8

The communication system according to Supplementary note 7, wherein

the configuration providing device further comprises instruction accept means for accepting an instruction as to whether or not to take over the configuration information stored in association with the first user identification information corresponding to the second user identification information, and

when the instruction to take over the configuration information is received, the configuration information transmission means transmits the configuration information as the configuration information for the second communication device.

### Supplementary Note 9

A configuration providing method comprising:

storing first device identification information for identifying a first communication device, configuration information of the first communication device, and first user identification information for identifying a user of the first communication device in association with each other;

receiving second device identification information for identifying a second communication device and second user identification information for identifying a user of the second communication device; and

transmitting the configuration information stored in association with the first user identification information corresponding to the second user identification information as configuration information for the second communication device.

### Supplementary Note 10

A non-transitory computer readable medium storing a program for causing a computer to execute:

a storage control step of controlling first device identification information for identifying a first communication device, configuration information of the first communication device, and first user identification information for identifying a user of the first communication device to be stored in association with each other;

a reception step of receiving second device identification information for identifying a second communication device and second user identification information for identifying a user of the second communication device; and

a configuration information transmission step of transmitting the configuration information stored in association with the first user identification information corresponding to the second user identification information as configuration information for the second communication device.

### REFERENCE SIGNS LIST

1 CONFIGURATION PROVIDING DEVICE
2 STORAGE CONTROL UNIT
3 RECEPTION UNIT
4 CONFIGURATION INFORMATION TRANSMISSION UNIT
10 COMMUNICATION SYSTEM
100 CONFIGURATION PROVIDING DEVICE
101 ID MANAGEMENT UNIT
102 STORAGE CONTROL UNIT
103 INFORMATION STORAGE UNIT
104 TAKEOVER INSTRUCTION ACCEPT UNIT
105 CONFIGURATION INFORMATION CORRECTION UNIT
106 CONFIGURATION INFORMATION TRANSMISSION UNIT
150 NETWORK INTERFACE
151 MEMORY
152 PROCESSOR
200 COMMUNICATION DEVICE
201 CONFIGURATION INFORMATION STORAGE UNIT
202 DATA TRANSMISSION/RECEPTION UNIT
203 PROCESSING UNIT
300 TERMINAL DEVICE
301 CODE READING UNIT
302 INPUT ACCEPT UNIT
303 DATA TRANSMISSION/RECEPTION UNIT
350 NETWORK INTERFACE
351 INPUT/OUTPUT DEVICE
352 MEMORY
353 PROCESSOR
354 CAMERA
400 INTRA-ORGANIZATION NETWORK
401 INFORMATION PROCESSING DEVICE
500 COMMUNICATION NETWORK

What is claimed is:

1. A configuration providing device comprising:
at least one memory storing program instructions; and
at least one processor configured to execute the instructions stored in the memory to:
control first device identification information for identifying a first communication device, configuration information of the first communication device, and first user identification information for identifying a user of the first communication device to be stored in association with each other;
receive second device identification information for identifying a second communication device and second user identification information for identifying a user of the second communication device; and
transmit the configuration information stored in association with the first user identification information corresponding to the second user identification information as configuration information for the second communication device.

2. The configuration providing device according to claim 1, wherein the processor is further configured to execute the instructions to:
accept an instruction as to whether or not to take over the configuration information stored in association with the first user identification information corresponding to the second user identification information, and
when the instruction to take over the configuration information is received, transmit the configuration information as the configuration information for the second communication device.

3. The configuration providing device according to claim 2, wherein the processor is further configured to execute the instructions to:
when there are a plurality of pieces of the first device identification information stored in association with the first user identification information corresponding to the second user identification information, accept an instruction to select one piece of the first device identification information, and
transmit the configuration information stored in association with the selected first device identification information as the configuration information for the second communication device.

4. The configuration providing device according to claim 1, wherein
the processor is further configured to execute the instructions to, when the configuration information of the first communication device as the configuration information for the second communication device is transmitted, control communication history information of the first communication device and communication history information of the second communication device to be stored in association with each other.

5. The configuration providing device according to claim 1, wherein
the processor is further configured to execute the instructions to, when a specification of the second communication device is different from a specification of the first communication device, transmit the configuration information changed according to the difference between the specification of the second communication device and the specification of the first communication device as the configuration information for the second communication device.

6. The configuration providing device according to claim 1, wherein
the first device identification information is read from a first two-dimensional code sent together with the first communication device and received together with the first user identification information, and
the second device identification information is read from a second two-dimensional code sent together with the second communication device and received together with the second user identification information.

7. A communication system comprising:
a second communication device in place of a first communication device; and
a configuration providing device, wherein
the configuration providing device comprises:
at least one first memory storing program instructions; and
at least one first processor configured to execute the instructions stored in the first memory to:
control first device identification information for identifying the first communication device, configuration information of the first communication device, and first user identification information for identifying a user of the first communication device to be stored in association with each other;
receive second device identification information for identifying the second communication device and second user identification information for identifying a user of the second communication device; and
transmit the configuration information stored in association with the first user identification information corresponding to the second user identification information as configuration information for the second communication device, and
the second communication device comprises:
at least one second memory storing program instructions; and
at least one second processor configured to execute the instructions stored in the second memory to perform predetermined processing based on the configuration information transmitted from the configuration providing device.

8. The communication system according to claim 7, wherein the first processor is further configured to execute the instructions to:
accept an instruction as to whether or not to take over the configuration information stored in association with the first user identification information corresponding to the second user identification information, and
when the instruction to take over the configuration information is received, transmit the configuration information as the configuration information for the second communication device.

9. A configuration providing method comprising:
storing first device identification information for identifying a first communication device, configuration information of the first communication device, and first user identification information for identifying a user of the first communication device in association with each other;
receiving second device identification information for identifying a second communication device and second user identification information for identifying a user of the second communication device; and
transmitting the configuration information stored in association with the first user identification information corresponding to the second user identification information as configuration information for the second communication device.

10. A non-transitory computer readable medium storing a program for causing a computer to execute:
a storage control step of controlling first device identification information for identifying a first communication device, configuration information of the first communication device, and first user identification information for identifying a user of the first communication device to be stored in association with each other;
a reception step of receiving second device identification information for identifying a second communication device and second user identification information for identifying a user of the second communication device; and
a configuration information transmission step of transmitting the configuration information stored in association with the first user identification information corresponding to the second user identification information as configuration information for the second communication device.
